(19) United States
(12) Patent Application Publication
(10) Pub. No.: US 2021/0146375 A1
(43) Pub. Date: May 20, 2021

(54) ROTOR SPEED CONTROL

(71) Applicant: Vermeer Manufacturing Company, Pella, IA (US)

(72) Inventors: Stephen Daining, Pella, IA (US); Rustin Bentzinger, Pella, IA (US); James O'Halloran, Pella, IA (US)

(21) Appl. No.: 17/162,777

(22) Filed: Jan. 29, 2021

Related U.S. Application Data
(63) Continuation of application No. 16/097,009, filed on Oct. 26, 2018, now abandoned.
(60) Provisional application No. 62/327,824, filed on Apr. 26, 2016.

(51) Int. Cl. B02C 25/00; B02C 18/14; B02C 21/02; B02C 13/30; B02C 18/24

(52) U.S. Cl. CPC B02C 25/00; B02C 18/146; B02C 21/026; B02C 2201/066; B02C 18/24; B02C 2021/023; B02C 13/30

(57) ABSTRACT

A material reducing apparatus includes a reducing head that includes a rotary reducing component that carries a plurality of cutters. The reducing head includes a thrown object deflector positioned proximate the rotary reducing component. The thrown object deflector is configured to limit at least one of a distance and a direction that objects can be thrown by the rotary reducing component.

### CROSS-REFERENCE TO RELATED APPLICATIONS

This application is a continuation of U.S. patent application Ser. No. 16/097,009, filed Oct. 26, 2018, which is the national stage of International Patent Application No. PCT/US2017/029357, filed Apr. 25, 2017, which claims the benefit of U.S. Provisional Patent Application No. 62/327,824, filed Apr. 26, 2016. Each of these applications is incorporated herein by reference in its entirety.

### BACKGROUND

Material reducing machines are machines used to reduce the size of material by processes such as mulching, chipping, grinding, cutting, or like actions. A typical material reducing machine includes a rotary reducing component that reduces material as the material reducing component rotates about a central axis. In certain examples, the rotary reducing component works in combination with other structures such as screens or anvils to facilitate the material reduction process. In certain examples, the rotary reducing component includes a main rotating body (e.g., a rotor, drum, plate stack, or like structures) and a plurality of reducing elements (e.g., knives, cutters, blades, hammers, teeth, or like structures) carried by the main rotating body. In certain examples, the reducing elements are positioned about a circumference of the main rotating body and are configured to define a circular cutting boundary as the rotary reducing component is rotated about its central axis.

A forestry mower is an example of one type of material reducing machine. A forestry mower typically includes a vehicle such as a tractor or skid-steer vehicle. A material reducing head is coupled to the vehicle (e.g., by a pivot arm or boom). The material reducing head includes a rotary reducing component, which often incorporates a rotating drum that carries a plurality of reducing blades. The material reducing head can be raised and lowered relative to the vehicle, and can also be pivoted/tilted forward and backward relative to the vehicle. By raising the reducing head and tilting the reducing head back, the forestry mower can be used to strip branches from trees and other aerial applications. By lowering the reducing head and pivoting the reducing head forward, the forestry mower can readily be used to clear brush, branches, and other material along the ground.

### SUMMARY

The present disclosure relates generally to a material reducing apparatus. In one possible configuration, and by non-limiting example, a thrown object distance is controlled by automatically controlling the speed of a rotary reducing component of the material reducing apparatus when the rotary reducing component is in certain positions.

In a first aspect of the present disclosure, a material reducing apparatus is disclosed. The material reducing apparatus includes a reducing head that includes a rotatable reducing component that carries a plurality of cutters. The reducing head includes a thrown object deflector positioned proximate the rotatable reducing component. The thrown object deflector is configured to limit at least one of a distance and a direction that objects can be thrown by the rotatable reducing component. The material reducing apparatus includes a sensor that is configured to measure, at least one of directly and indirectly, and at least one material reducing apparatus characteristic selected from the group consisting of at least one a position and orientation of the thrown object deflector, at least one of a position and orientation of the material reducing apparatus, and at least one of a position and an orientation of the reducing head. The sensor is configured to generate a sensor signal based upon the measurement made thereby. The material reducing apparatus includes a controller configured to receive the sensor signal. The controller is configured to automatically control a speed of rotation of the rotatable reducing component based on the sensor signal.

In a second aspect of the present disclosure, a method of automatically controlling the speed of a rotary reducing component is disclosed. The method includes providing a reducing head that includes a rotary reducing component that carries a plurality of cutters. The reducing head also includes a thrown object deflector positioned proximate the rotary reducing component. The thrown object deflector is configured to limit at least one of a distance and a direction that objects can be thrown by the rotary reducing component. The method includes sensing at least one material reducing apparatus characteristic selected from the group consisting of at least one of a position and an orientation of a reducing head, at least one of a position and an orientation of the thrown object deflector, and at least one of a position and an orientation of the material reducing machine. The method includes generating a sensor signal representative of the material reducing apparatus characteristic and controlling a speed of rotation of the rotary reducing component based on the sensor signal.

In a third aspect of the present disclosure, a vehicle is disclosed. The vehicle includes a main frame and a boom frame that is pivotally attached to the main frame. The vehicle includes a reducing head attached to the boom frame. The reducing head includes a rotary reducing component that carries a plurality of cutters. The reducing head also includes a thrown object deflector that is positioned proximate the rotary reducing component. The thrown object deflector is configured to limit at least one of a distance and a direction that objects can be thrown by the rotary reducing component. The vehicle includes a cylinder that is attached to the boom frame and to the reducing head for selectively tilting the reducing head with respect to the boom frame. The vehicle includes a sensor that is configured to measure an orientation of the reducing head. The sensor is configured to generate a sensor signal based upon the measurement made by the sensor. The vehicle includes a controller that is configured to receive the sensor signal. The controller is configured to automatically control a speed of rotation of the rotary reducing component based on the sensor signal.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates a perspective view of a material reducing apparatus according to one embodiment of the present disclosure;

FIG. 2 illustrates a side view of the material reducing apparatus of FIG. 1;

FIG. 3 illustrates a bottom perspective view of the material reducing apparatus of FIG. 1;

FIG. 4 illustrates a schematic cross section view of a material reducing head of the material reducing apparatus of FIG. 1 in a first position;

FIG. 5 illustrates a schematic cross section view of a material reducing head of the material reducing apparatus of FIG. 1 in a second position;

FIG. 6 illustrates a control schematic of the material reducing apparatus of FIG. 1;

FIG. 7 illustrates a schematic cross section view of a material reducing head having a thrown object deflector, according to one embodiment of the present disclosure;

FIG. 8 illustrates a schematic cross section view of the material reducing head and thrown object deflector of FIG. 7 with the thrown object deflector in a first position; and

FIG. 9 illustrates a schematic cross section view of the material reducing head and thrown object deflector of FIG. 7 with the thrown object deflector in a second position.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The machine and associated control system disclosed herein has several advantages. For example, a thrown object distance is controlled by automatically controlling the speed of a rotary reducing component of a material reducing apparatus when the rotary reducing component is in certain positions. Further, the control system is configured to allow the rotary reducing component to operate at higher, more effective speeds when in certain other positions.

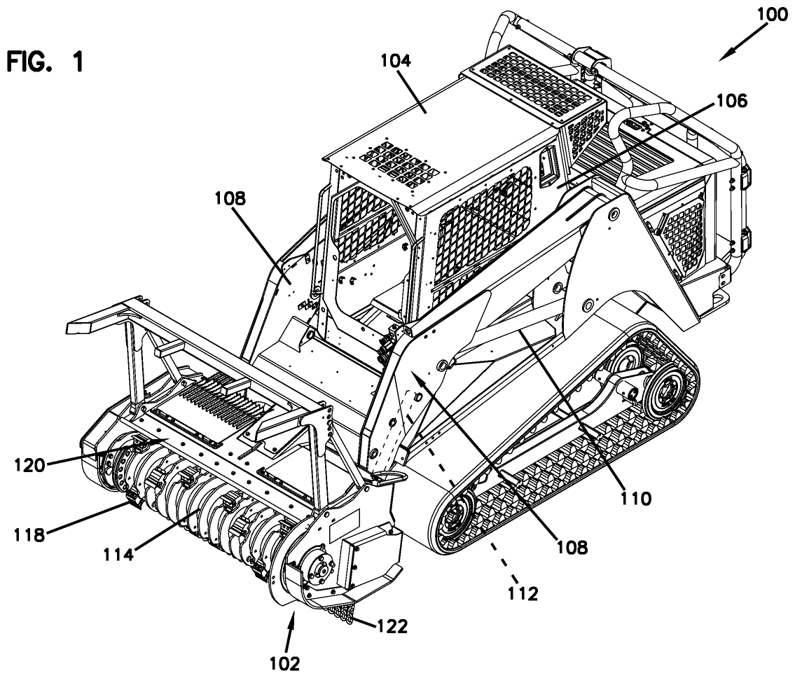

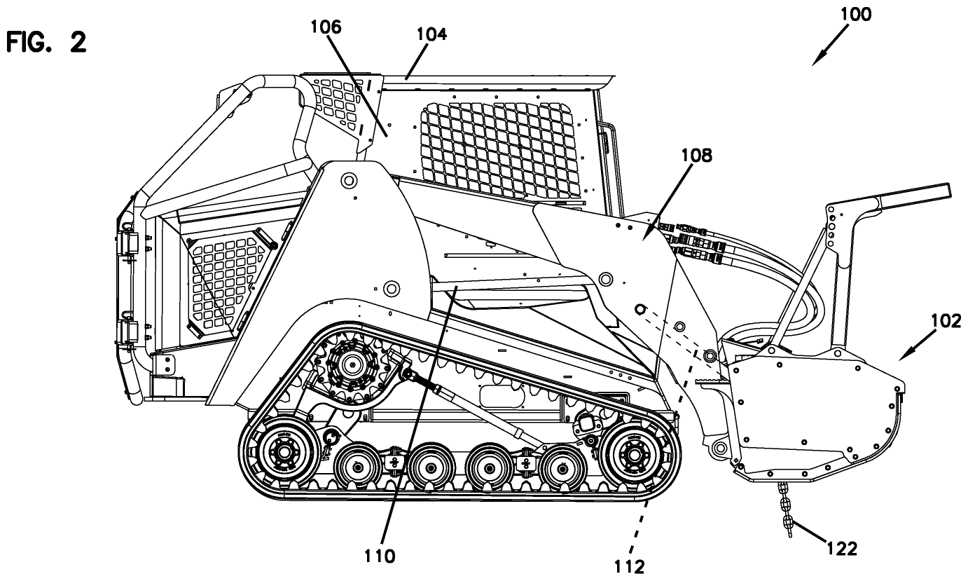

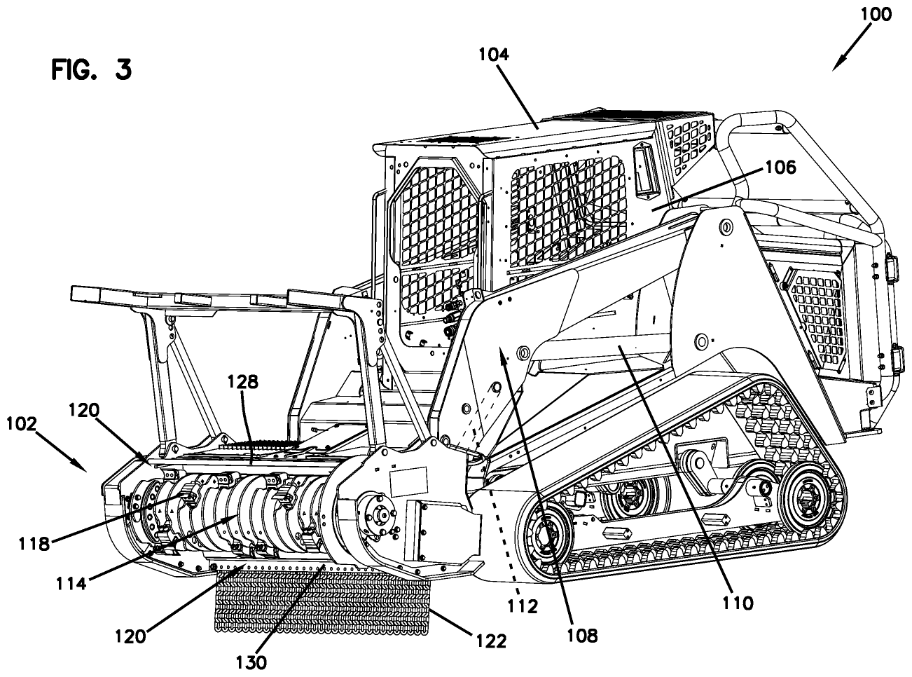

FIGS. 1-3 illustrate a material reducing apparatus in accordance with the principles of the present disclosure. As depicted, the material reducing apparatus is shown as a forestry machine 100 (also known, for example, as a forestry mower or forestry mulcher) including a material reducing head 102 carried by a vehicle 104. The vehicle 104 is depicted as a track loader, but could be any other type of vehicle, such as a wheeled or tracked tractor. The vehicle 104 includes a main frame 106. A linkage (e.g., a boom 108 including a boom arm, a pair of spaced-apart boom arms, or other structures) connects the material reducing head 102 to the frame 106 of the vehicle 104. Cylinders 110 can be used to pivot the boom 108 up and down to raise and lower the material reducing head 102 relative to the frame 106. Hydraulic cylinders 112 can be used to pivot the material reducing head 102 and to tilt the material reducing head 102 forwardly and rearwardly relative to the frame 106.

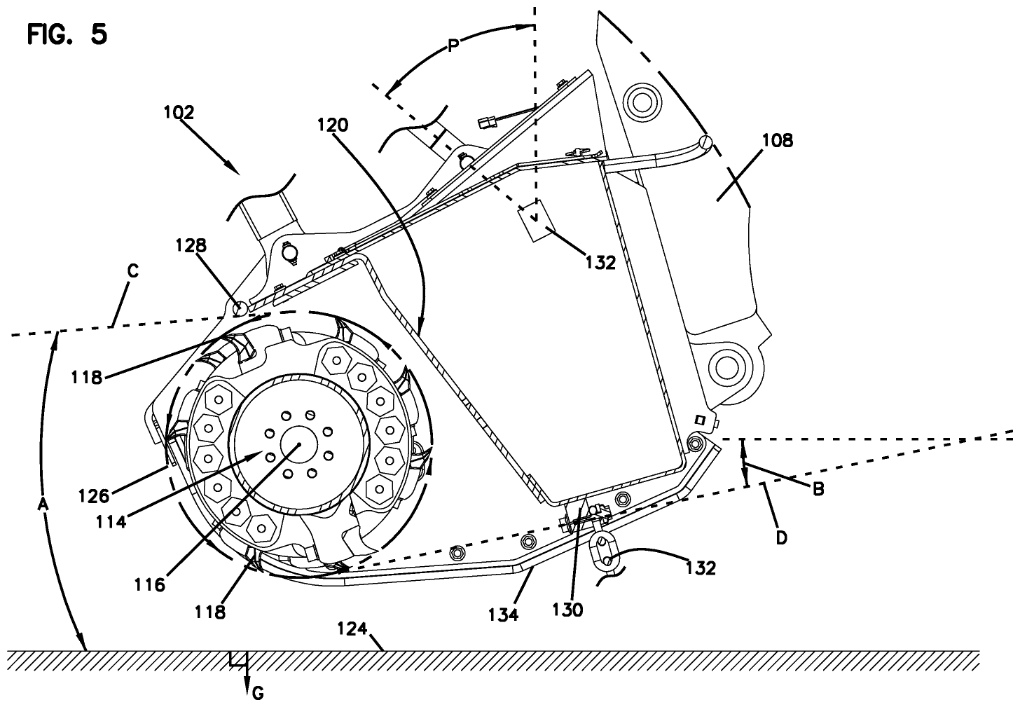

The material reducing head 102 includes a rotary reducing component 114 that is rotated about a central axis 116. At least one hydraulic motor 152 (see schematic representation at FIG. 5) can be provided for rotating the rotary reducing component 114 about the central axis 116. The rotary reducing component 114 can include a drum or other main body which carries a plurality of reducing elements 118 (e.g., blades, knives, hammers, etc., or combinations thereof).

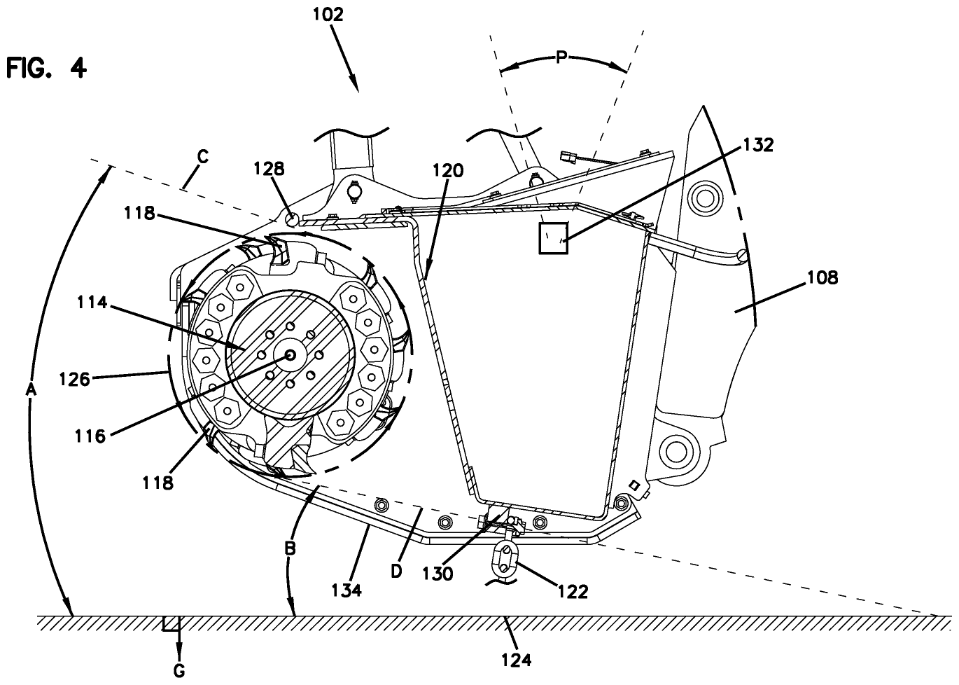

The material reducing head 102 includes a thrown material deflector 120 (e.g., a cover or guard) at least partially surrounding the rotary reducing component 114. In the depicted embodiment, the thrown material deflector 120 is fixed relative to the rotary reducing component 114. The thrown material deflector 120 can include a plurality of plates and shields that partially surround the rotary reducing component 114. As shown in FIGS. 1-3, the thrown material deflector 120 can also include a plurality of free hanging chain components 122. The chain components 122 can be used to knock debris down; however, unlike the thrown material deflector 120, the chains 122 swing freely from the reducing head 102 and offer a less rigid deflector when compared to the thrown material deflector 120. Specifically, as shown in FIG. 4, the thrown material deflector 120 aids in controlling a forward thrown object trajectory angle A and a rearward thrown object trajectory angle B of the forestry machine 100. The forward thrown object trajectory angle A is an angle between a ground surface 124 and a reference plane C. The reference plane C is tangential to a reducing circle 126 of the rotary reducing component 114 and coincident with a leading edge 128 of the thrown material deflector 120. The rearward thrown object trajectory angle B is an angle between the ground surface 124 and a reference plane D. The reference plane D is tangential to the reducing circle 126 of the rotary reducing component 114 and coincident with a trailing edge 130 of the thrown material deflector 120. Because a thrown object will travel in a direction back toward the vehicle 104, a negative rearward thrown object trajectory angle B will result in a thrown object trajectory that is in a direction away from the ground (shown in FIG. 5).

FIG. 4 also shows the material reducing head 102 further including a sensor, which, in the illustrated embodiment, is in the form of transducer 132. The transducer 132 is configured to measure a material reducing apparatus characteristic such as a position/orientation of the thrown object deflector 120, the position/orientation of the forestry machine 100, or a position/orientation of the reducing head 102. In some embodiments, the transducer 132 is mounted elsewhere on the forestry machine 100 such as on the frame 106. In still other embodiments, the forestry machine 100 can include multiple transducers 132 located in a variety of locations on the forestry machine 100 to measure a plurality of different material reducing apparatus characteristics. It is to be understood, however, that the sensor(s) could take other forms and still be within the scope of the present system. For example, in some embodiments, a linear position sensor can be in communication with the hydraulic cylinders 112 so as to output a signal representative of the position of the cylinders 112, which can then be used to measure a tilt of the reducing head 102.

In the depicted embodiment, the transducer 132 is an inclinometer that measures a pitch P of the material reducing head 102 with respect to gravity G. In some embodiments, the transducer 132 is calibrated. For example, the transducer 132 can measure the difference in pitch P between an operating position (current position) of the material reducing head 102 and a reference position. The operational position of the material reducing head 102 can be a position when the material reducing head 102 is tilted by the hydraulic cylinders 112 in a direction toward the ground 124 or away from the ground 124. In some embodiments, the reference position of the material reducing head 102 can be a position when a lower portion 134 of the reducing head 102 is generally parallel with the ground surface 124. In some embodiments, the transducer 132 measures a pitch P when the reducing head 102 is in the reference position, thus creating a calibration measurement. As the reducing head 102 is tilted during operation, the transducer 132 then measures the difference in pitch P between the operation position and the calibration measurement. This allows the transducer 132 to be mounted in a variety of locations and in a variety of different positions. As the material reducing head 102 changes operating positions, the forward thrown object trajectory angle A and the rearward thrown object trajectory angle B change. These angles A, B can be correlated to pitch measurements by the transducer 132, thereby allowing the user to control the angles A, B based on the measurements of the transducer 132.

During normal operation, when viewing the cross section of the rotary reducing component 114 from the left side of the forestry mower 100 (as shown in FIG. 4), the rotary reducing component 114 rotates in a counter clockwise direction. Due to this rotation of the rotary reducing component 114, as the forward thrown object trajectory angle A increases, the distance a thrown object can travel away from the forestry mower 100 is increased until the angle A reaches about 45 degrees. Further, as noted above, as angle B becomes negative, the distance a thrown object can travel in a direction back toward the forestry mower 100 increases (in some embodiments, the distance increases until the angle B reaches about (−)45 degrees), if the object indeed is able to miss the forestry mower 100. FIG. 5 shows the scenario when angle B is negative as the reducing head 102 is tilted toward the ground 124.

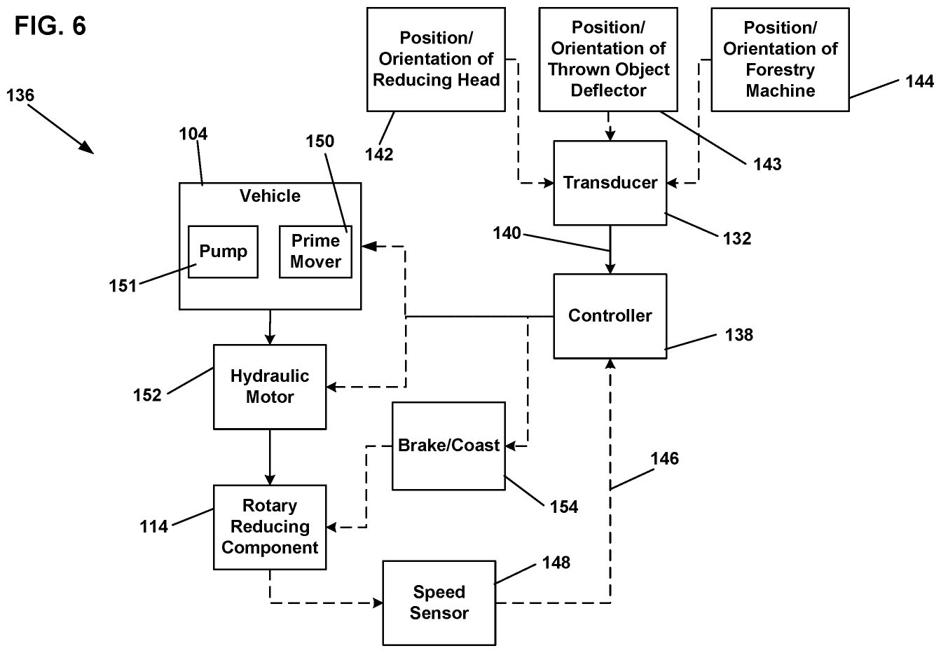

FIG. 6 shows an example control system 136 for the forestry mower 100. The control system 136 is configured to control the rotational speed of the rotary reducing component 114 to limit a distance that objects can be thrown by the rotary reducing component 114. For example, by reducing the rotational speed of the rotary reducing component 114 when the pitch P measured by the transducer 132 exceeds a preset value (such a value depends on the reference position and calibrated measurement, described above), the distance of a thrown object is limited. In some embodiments, this pitch P corresponds with a forward thrown object trajectory angle A that exceeds a preset maximum value. In the case of rearward thrown object trajectory angle B, this pitch P corresponds with an angle B that is less than a preset value, because the angle B is negative when the thrown object trajectory is positive in a direction back toward the vehicle 104. In some embodiments, an absolute value system can be used for angle B. In such an embodiment, an absolute value of angle B can be compared to an absolute value of a present value, and when a pitch P corresponds to an angle B that exceeds a preset value the distance of a thrown object can be limited. Because the rotary reducing component 114 more effectively reduces material it encounters when rotating at a high speed, the control system 136 allows the rotary reducing component 114 to rotate at a relatively high rate when between preset maximum values of angles A, B which correlate with particular pitch P measurements of the transducer 132.

The control system 136 includes a controller 138 that is in communication with the transducer 132, allowing the controller 138 to receive inputs from the transducer 132. The input provided by the transducer 132 can be in the form of a signal 140. In the depicted embodiment, the signal 140 can be indicative of a position/orientation of the reducing head signal 142, a position/orientation of the thrown object deflector 143, or a position/orientation of the forestry machine signal 144. In the some embodiments, the thrown material deflector 120 is fixed relative to the reducing head 102 so the position of the reducing head 102 can be representative of the position of the thrown material deflector 120. In some embodiments, the transducer 132 can provide multiple signals to the controller 138 in the form, for example, of transmissions corresponding to the position/orientation of the reducing head signal 142, the position/orientation of the thrown object deflector 143, and the position/orientation of the forestry machine signal 144.

In some embodiments, the controller 138 can also receive a speed signal 146 from a speed sensor 148 that is configured to measure the rotational speed of the rotary reducing component 114.

The controller 138 uses the inputs it receives to control the rotational speed of the rotary reducing component 114. In the depicted embodiment, controlling the speed of the rotary reducing component 114 can be achieved by controlling the operation of a vehicle 104 of the forestry mower 100 or the hydraulic motor 152 of the forestry mower 100. In the depicted embodiment, the vehicle includes a prime mover 150 and a pump 151 that control the operation of the hydraulic motor 152, and the hydraulic motor 152 controls the rotational speed of the rotary reducing component 114.

In the depicted embodiment, the prime mover 150 can be an internal combustion engine, electric motor, or other similar hybrid-type engine. The prime mover 150 provides power to the hydraulic motor 152. In some embodiments, the prime mover 150 first powers the pump 151 that then provides a hydraulic fluid flow to the hydraulic motor 152. In some embodiments, the controller 138 can control the prime mover 150's output speed. In some embodiments, the controller 138 alters the prime mover 150's RPM's (i.e., throttling up or throttling down). In some embodiments, the controller 138 alters the prime mover's output by altering the output of the pump 151 that supplies hydraulic flow to the hydraulic motor 152. In some embodiments, the output of the pump 151 can be altered by changing the displacement of the pump 151. By controlling the prime mover 150 or the pump 151, the hydraulic motor 152 is then controlled, which can then control, for example, the rotational speed of the rotary reducing component 114. For example, by reducing the RPM's of prime mover 150, output from the hydraulic motor 152 is lowered, which then slows the rotational speed of the rotary reducing component 114. In some embodiments, the rotary reducing component 114 is powered through a transmission (not shown) configured to generate a related number of RPM's. By controlling the transmission to control output, the speed of rotation of the rotary reducing component 114 can also be controlled.

In some embodiments, the hydraulic motor 152 is a fixed displacement motor. In other embodiments, the hydraulic motor 152 is a variable displacement motor, such as an axial piston motor. When the hydraulic motor 152 is an axial piston motor, the motor 152 can include a movable swash plate (not shown). By changing the position of the swash plate, the displacement of the motor can be altered. Therefore, in some embodiments, the controller 138 can control the position of the swash plate of the hydraulic motor 152 to alter the output of the motor 152, thereby controlling the rotational speed of the rotatory reducing component 114. In some embodiments, the controller 138 will decrease motor displacement, thereby increasing the rotational speed of the rotary reducing component 114 when the controller 138 determines that the distance and trajectory of the potential thrown object are within a calculated range. Alternatively, the controller 138 will increase motor displacement, thereby decreasing the rotational speed of the rotary reducing component 114 when the controller 138 determines that the distance and trajectory of the potential thrown object are outside of a calculated range.

In some embodiments, the controller 138 allows the rotary reducing component 114 to rotate at a maximum speed when the operating position pitch P, the forward thrown object trajectory angle A, and the rearward thrown object trajectory angle B are within a set range of values. As noted above, speed can be reduced once the controller receives a signal from the transducer 132 that the operating position pitch P the forward thrown object trajectory angle A exceeds preset maximum values. In other embodiments, the controller 138 is configured to continuously vary the maximum operating speed of the rotary reducing component 114 based on signals it receives from the transducer 132. In some embodiments, the controller 138 may use a preset look-up table or best-fit line approximation that corresponds with pitch P, forward thrown object trajectory angle A, and rearward thrown object trajectory angle B values to determine the desired hydraulic motor 152 displacement or desired prime mover 150 output to control the thrown object distance.

In still other embodiments, the controller 138 can control a brake 154 that can either stop the rotation of the rotary reducing component 114 or allow it to freely coast. Stopping the rotation of rotary reducing component 114 or allowing it to freely coast, unpowered, can be advantageous in situations where the controller 138 determines that a thrown object distance is extreme. In other embodiments, the operator may want to brake or allow the rotary reducing component 114 to coast during operation. In still other embodiments, the brake 154 may be controlled to slow yet not completely stop the rotation of rotary reducing component 114.

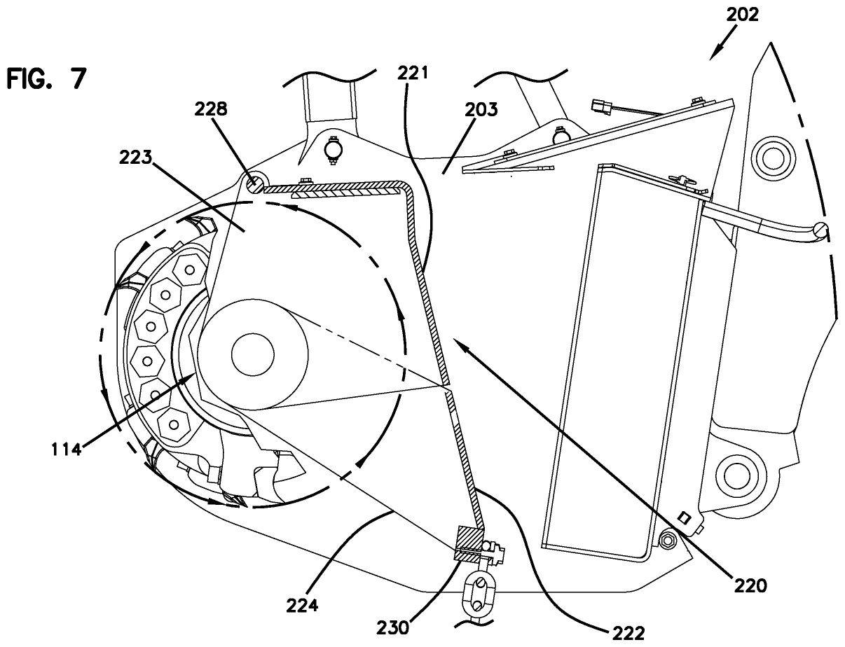

FIGS. 7-9 show a thrown object deflector 220 according to one embodiment of the present disclosure. The thrown object deflector 220 is similar to the thrown object deflector 120 described above; however, as shown in FIGS. 7-9, the thrown object deflector 220 is movable. As shown, a reducing head 202 includes a main frame 203 that at least partially surrounds the rotary reducing component 114. The thrown object deflector 220 includes a leading edge deflector 221, and a trailing edge deflector 222. The leading edge deflector 221 includes a leading edge 228 and the trailing edge deflector 222 includes a trailing edge 230. Each deflector 221, 222 can be separately movable so as to change the position of the leading edge 228 and the trailing edge 230 respectively. A first frame 223 is connected to the leading edge deflector 221 and a second frame 224 is connected to the trailing edge deflector 222. Both the first and second frames 223, 224 can be mounted to the main frame 203 and independently movable. In some embodiments, the leading and trailing edge deflector 221, 222 may be connected. In some embodiments, actuators are used to move and position the first and second frames 223, 224. In some embodiments, the first and second frames and or the deflectors 221, 222 can include sensors capable of measuring their positions and relaying such measurements to the controller 138.

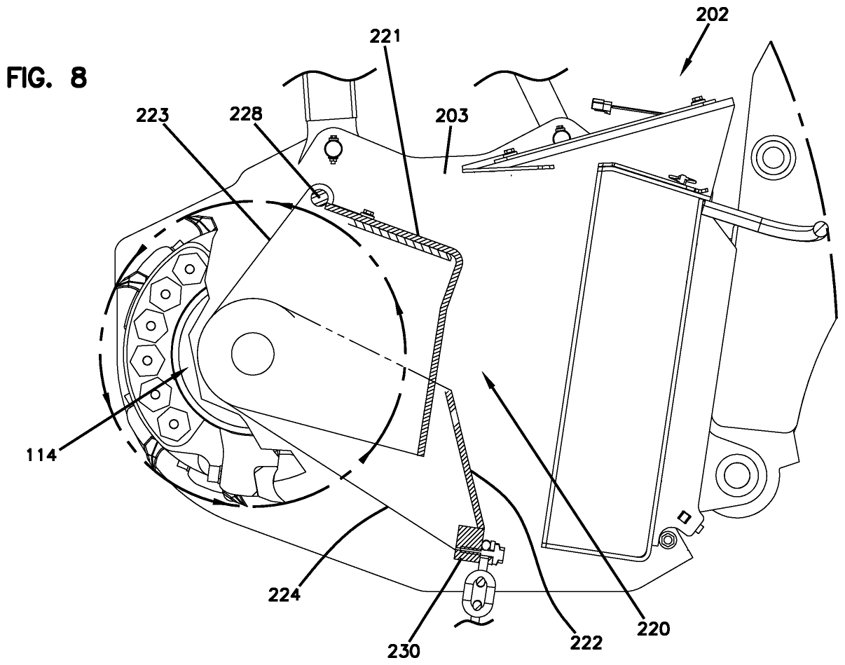

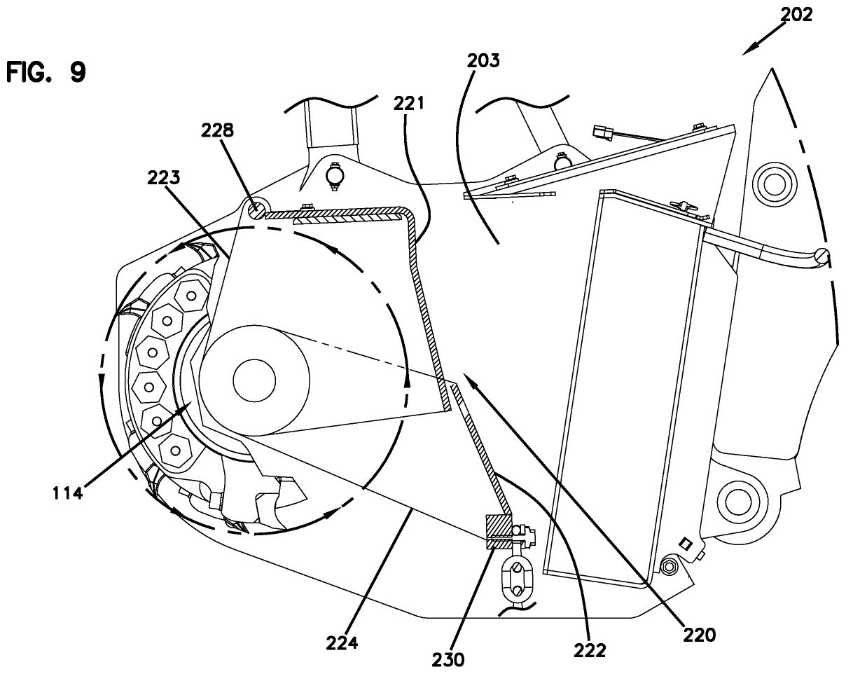

FIG. 8 shows the first frame 221 positioning the leading edge deflector 221 in a second, lower position. The reducing head 202, main frame 203, and trailing edge deflector 223 all remain in the same position as shown in FIG. 8. By changing the position of the leading edge deflector, specifically the leading edge 228, the thrown object distance can be altered. Similarly, FIG. 9 shows the second frame 222 positioning the trailing edge deflector 222 in a second, higher position.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A material reducing apparatus comprising:
a main frame;
a boom frame pivotally attached to the main frame;
a reducing head attached to the boom frame, a reducing head including a rotary reducing component that carries a plurality of cutters, the reducing head also including a thrown object deflector positioned proximate the rotary reducing component, the thrown object deflector being configured to limit at least one of a distance and a direction that objects can be thrown by the rotary reducing component;
a sensor being configured to measure, at least one of directly and indirectly, at least one material reducing apparatus characteristic selected from the group consisting of at least one of a position and an orientation of the reducing head, at least one of a position and an orientation of the thrown object deflector, and at least one of a position and an orientation of the material reducing apparatus, the sensor further being configured to generate a sensor signal based upon the measurement made thereby; and
a controller configured to receive the sensor signal, the controller being configured to automatically control a speed of rotation of the rotary reducing component based on the sensor signal.

2. The material reducing apparatus of claim 1, wherein the sensor is mounted to the reducing head.

3. The material reducing apparatus of claim 1, wherein the controller is configured to automatically control the speed of rotation of the rotary reducing component based only on the orientation of the material reducing apparatus.

4. The material reducing apparatus of claim 1, wherein the controller is configured to automatically control the speed of rotation of the rotary reducing component based only on the position of the thrown object deflector.

5. The material reducing apparatus of claim 1, wherein the controller is configured to automatically control the speed of rotation of the rotary reducing component based on both the orientation of the material reducing apparatus and the position of the thrown object deflector.

6. The material reducing apparatus of claim 1, wherein the rotary reducing component is powered by a hydraulic motor, and wherein the controller alters the displacement of the hydraulic motor to control the speed of the rotary reducing component.

7. The material reducing apparatus of claim 6, wherein the hydraulic motor is an axial piston motor having a swash plate, and wherein the controller controls the position of the swash plate to alter the displacement of the hydraulic motor.

8. The material reducing apparatus of claim 1, further comprising a speed sensor being configured to measure the rotational speed of the rotary reducing component, wherein the controller is configured to receive signals from the speed sensor.

9. The material reducing apparatus of claim 1, wherein the rotary reducing component is powered by an engine configured to generate a related number of RPM's, and wherein the controller controls the engine's RPM's to control the speed of rotation of the rotary reducing component.

10. The material reducing apparatus of claim 1, wherein the controller is configured to automatically control the speed of rotation of the rotary reducing component by selectably braking the rotary reducing component.

11. The material reducing apparatus of claim 1, wherein the controller is configured to automatically control the speed of rotation of the rotary reducing component by selectably allowing the rotary reducing component to freely coast.

12. The material reducing apparatus of claim 1, further comprising a cylinder attached to the boom frame and to the reducing head for selectively tilting the reducing head with respect to the boom frame, wherein the sensor is a linear position sensor attached to the cylinder for sensing the material reducing apparatus characteristic.

13. The material reducing apparatus of claim 1, wherein the rotary reducing component is powered by a hydraulic pump configured to supply a hydraulic fluid flow to a hydraulic motor, and wherein the controller controls the hydraulic flow supplied by the pump to control the speed of rotation of the rotary reducing component.

14. The material reducing apparatus of claim 1, wherein the rotary reducing component is powered through a transmission configured to generate a related number of RPM's, and wherein the controller controls the transmission to control the speed of rotation of the rotary reducing component.

15. The material reducing apparatus of claim 1, wherein the material reducing apparatus is a forestry machine.

16. A method of automatically controlling the speed of a material reducing apparatus comprising:
providing a main frame and a boom, the boom being pivotally mounted to the main frame;
providing a reducing head mounted to the boom including a rotary reducing component that carries a plurality of cutters, the reducing head also including a thrown object deflector positioned proximate the rotary reducing component, the thrown object deflector being configured to limit at least one of a distance and a direction that objects can be thrown by the rotary reducing component;
sensing at least one material reducing apparatus characteristic selected from a group consisting of at least one of a position and an orientation of the reducing head, at least one of a position and an orientation of the thrown object deflector, and at least one of a position and an orientation of the material reducing apparatus;
generating a sensor signal representative of the material reducing apparatus characteristic; and
controlling a speed of rotation of the rotary reducing component based on the sensor signal.

17. The method of claim 16, further comprising altering the displacement of a hydraulic motor that powers the rotation of the rotary reducing component to control the speed of the rotary reducing component.

18. The method of claim 16, further comprising controlling an engine's RPM's to control the speed of rotation of the rotary reducing component, wherein the rotary reducing component is powered by the engine.

19. The method of claim 16, further comprising applying a braking force to the rotary reducing component to control the speed of the rotary reducing component.

20. The method of claim 16, further comprising selectably allowing the rotary reducing component to freely coast to control the speed of rotation of the rotary reducing component.

21. A vehicle comprising:
a main frame;
a boom frame pivotally attached to the main frame;
a reducing head attached to the boom frame, the reducing head including a rotary reducing component that carries a plurality of cutters, the reducing head also including a thrown object deflector positioned proximate the rotary reducing component, the thrown object deflector being configured to limit at least one of a distance and a direction that objects can be thrown by the rotary reducing component;
a cylinder being attached to the boom frame and to the reducing head for selectively tilting the reducing head with respect to the boom frame;
a sensor being configured to measure an orientation of the reducing head, the sensor being configured to generate a sensor signal based upon the measurement made thereby; and
a controller configured to receive the sensor signal, the controller being configured to automatically control a speed of rotation of the rotary reducing component based on the sensor signal.

22. The vehicle of claim 21, wherein the sensor is mounted to the reducing head.
